(19) United States
(12) Patent Application Publication
(10) Pub. No.: US 2010/0106963 A1
(43) Pub. Date: Apr. 29, 2010

(54) System and method for secure remote computer task automation

(75) Inventors: Anthony Virtuoso, East Rutherford, NJ (US); Miles Avery Dolphin, Jersey City, NJ (US)

Correspondence Address: LEHMAN BROTHERS INC.;C/O MORGAN, LEWIS & BOCKIUS, LLP, 1111 PENNSYLVANIA AVE. N.W., WASHINGTON, DC, 20004, US

(73) Assignee: Barclays Capital Inc., New York, NY (US)

(21) Appl. No.: 12/385,846

(22) Filed: Apr. 21, 2009

Related U.S. Application Data
(60) Provisional application No. 61/071,323, filed on Apr. 22, 2008.

(51) Int. Cl. H04L 29/06

(52) U.S. Cl. 713/155

(57) ABSTRACT

A system includes a third party authority in communication with a client computer and a target computer. The third party authority is configured to receive a request including authentication information and an access request from the client computer. The third party authority is configured to authenticate the client computer based on the authentication information and to process the access request to grant the client computer access to the target computer to perform a task on the target computer, the access request including the task. The third party authority is further configured to send an access token to the client computer to access the target computer to perform the task, to receive the access token from the target computer for validation, to validate the received access token based on the request for the target computer to process the task, and to grant the target computer permission to process the task upon validation.

This application claims the benefit of the U.S. Provisional Patent Application No. 61/071,323 filed on Apr. 22, 2008, which is hereby incorporated by reference.

### BACKGROUND OF THE INVENTION

1. Field of the Invention

The present invention relates to a system and method for secure remote computer task automation.

2. Discussion of the Related Art

As information technology continues to develop, computer networks are becoming more distributed over longer distances. Remote access and control of computers on a network becomes essential in managing and maintaining proper operation of the network in a timely manner. However, such remote control and access architecture brings with it various security challenges.

For example, to execute certain commands on a remotely located computer (i.e., “target computer”) from a client computer, the target computer needs to give the client computer access rights. To obtain access rights, the client computer must send the target computer certain login information to be authenticated. However, login information may contain sensitive information that may be used to breach the network on the client computer side should the login information fall into the wrong hands. Furthermore, existing remote access solutions grant administrative rights (i.e., highest level of access rights) to the client computer once the client computer is authenticated, meaning that the client computer can execute any command or perform any task on the target computer, thereby increasing the risk of harming the target computer if unintended commands are executed or of hijacking if the client computer is breached through the authentication process. What is needed is a more secure remote computer access and control solution.

### SUMMARY OF THE INVENTION

Accordingly, the present invention is directed to a system and method for secure remote computer task automation that substantially obviates one or more problems due to limitations and disadvantages of the related art.

An object of the present invention is to provide a system and method for secure remote access, control, and monitoring of a target computer from a client computer.

Another object of the present invention is to provide a system and method of secure remote access, control and monitoring of a target computer from a client computer using third party authentication and authorization of the remote access and control.

Yet another object of the present invention is to provide a system and method of secure remote access, control and monitoring of a target computer from a client computer using varying levels of access granularity.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description and drawings are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a system diagram of an exemplary embodiment of the present invention; and

FIGS. 2A-2C are an exemplary process flow in accordance with the present invention.

### DETAILED DESCRIPTION OF THE INVENTION

Reference will now be made in detail to the embodiments of the present invention, examples of which are illustrated in the accompanying drawings.

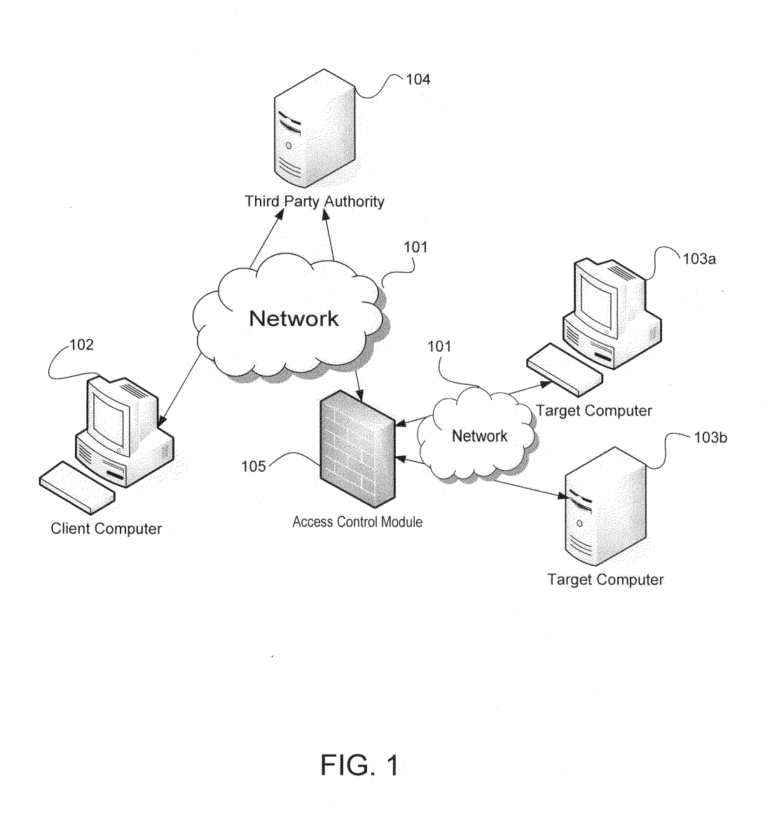

FIG. 1 illustrates an exemplary embodiment of the present invention. As shown in FIG. 1, the system and method for secure remote computer task automation includes a client computer 102, a target computer 103a and 103b, a third party authority 104, and an access control module 105. A communication network 101 facilitates communication between each of these components and may include a client computer's network, a target computer's network, or a third party authority's network.

The communication network 101 may be a local area network (LAN), wide area network (WAN), distributed networks such as the Internet, or any other communications medium (e.g., point-to-point connections). The communication network may be wired or wireless.

The client computer 102 and target computer 103a and 103b may be stand-alone devices, such as desktop computers, notebook computers, workstations, or other computing devices connected to the communication network 101, or may be computing devices acting as servers or mainframes of a computing network, for example. The client computer 102 and target computer 103a and 103b may have their own local security schemes to protect their credentials and communications channels.

The third party authority 104 may be a separate computing device external to the client computer and the target computer 103a and 103b, or may be an internal service on either device. If the third party authority 104 is implemented on an external computing device, the third party authority 104 may be external to the client computer's network and/or the target computer's network without departing from the scope of the invention.

The third party authority 104 may have increased security compared with the client computer 102 or target computer 103a and 103b as these components may not be as trusted as the third party authority 104. In an exemplary embodiment, the third party authority 104 may be used to control interactions between the client computer 102 and target computers 103a and 103b, including allocating access tokens exchanged between client computer 102 and target server 103a and 103b. In this case, if any one of the components shown in FIG. 1 is compromised, there is little to no security risk.

The access control module 105 also may be implemented as a separate computing device or as a service on any one of the client computer 102, target computer 103a and 103b, or third party authority 104. For example, the access control module 105 may run as a multi-threaded service on target computer 103a and 103b that attaches itself to the STD-IN, STD-OUT, and STD-ERR of a command being run on the target computer 103a and 103b. Moreover, the access control module 105 may be part of the client computer's network 101, the target computer's network 101, or the third party authority's network 101.

The access control module 105 may have its own read-block avoidance system because certain client computer 102 requests may not produce a termination string, thus leading to a permanently blocked thread or process on the target computer 103a and 103b. The access control module 105 may perform a buffered read in a separate thread and then require the client computer 102 to specify a timeout manually. The thread may continually attempt to read from the specified stream.

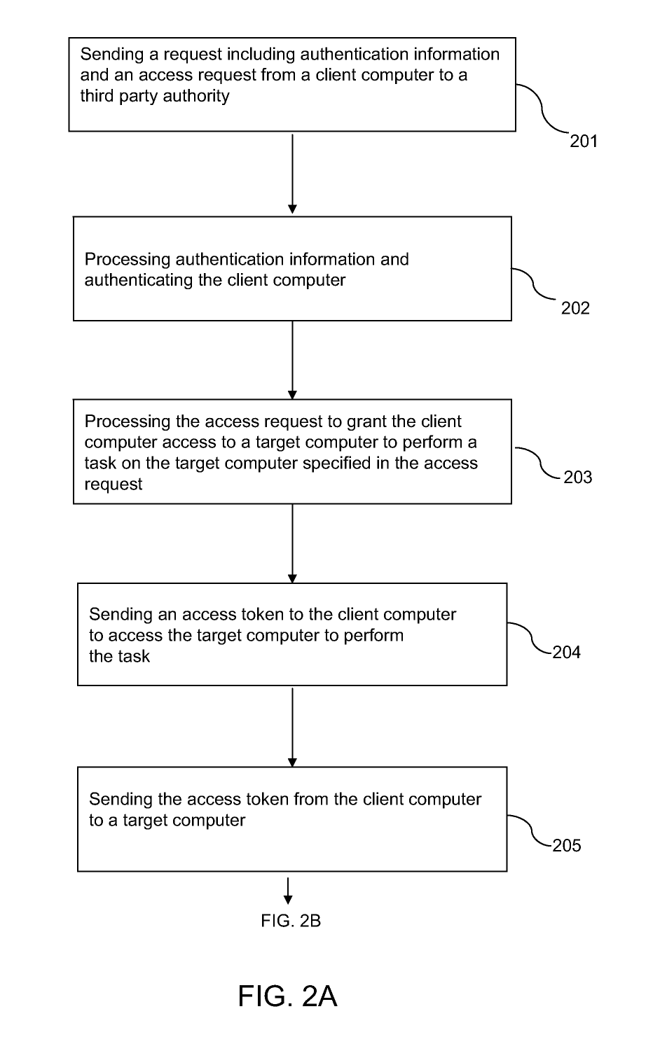

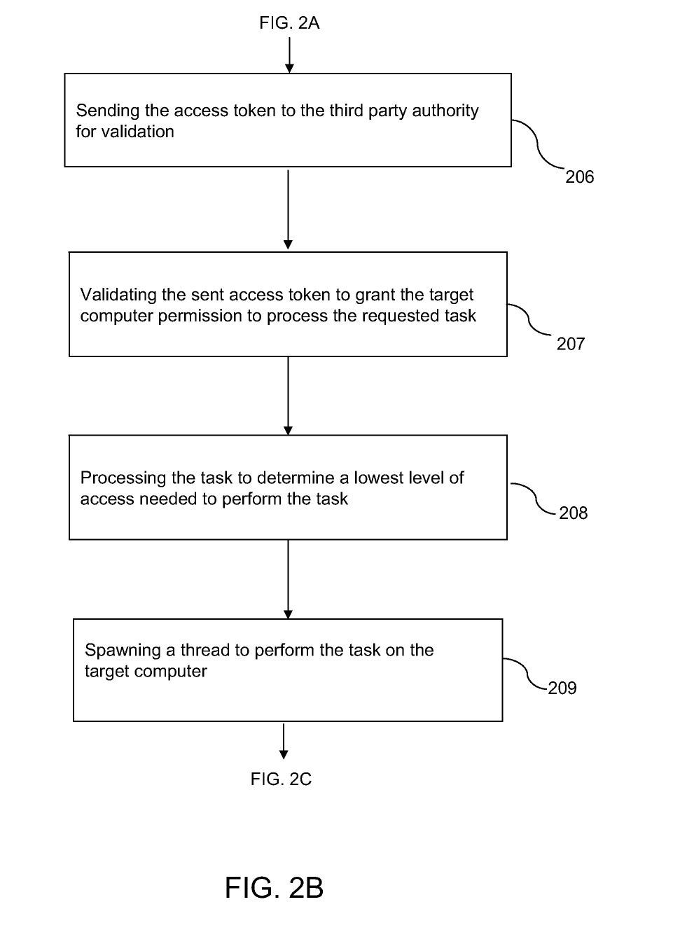

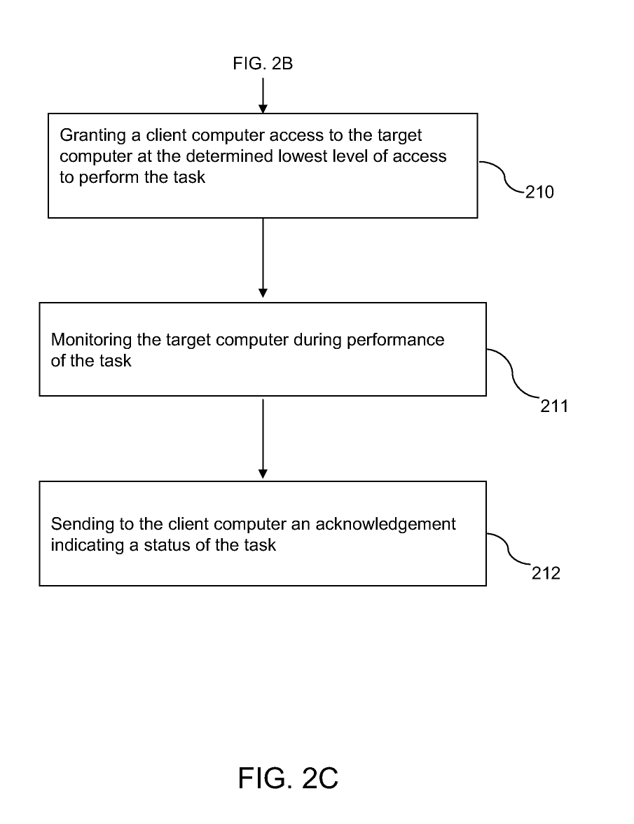

FIG. 2A-2B illustrate an exemplary process flow in accordance with the present invention. The remote access, control, and monitoring described herein may be initiated manually by a user on a client computer 102 or may be automated to perform system maintenance, for example.

In accordance with the present invention, the client computer establishes a secure communication channel. For example, the secure communication channel may be established over communication network 101. At step 201, to obtain access permission to the target computer 103a and 103b, the client computer 102 sends the third party authority 104, authentication information and an access request through the secure communication channel established between the client computer 102 and the third party authority 104. The authentication information may include identity of the user and/or client computer 102, password, and/or any additional authentication data (e.g., PIN, secure key, etc.). The access request may include the identity of the target computer 103a and 103b (e.g., computer name, IP address, etc.) and the intended purpose of the access, such as an instruction, instructions, programs, or commands to be executed on the target computer 103a and 103b or a task to be performed on the target computer 103a and 103b. The access request may also include a request for an access token. The authentication information and access request sent to the third party authority 104 may be encrypted. In an exemplary embodiment, prior to the access request and authentication information being sent to the third party authority 104, client computer 102 may perform error checking to determine if formatting of the request is correct.

At step 202, the third party authority 104 processes the authentication information to verify the identity of the client computer 102 to determine if the client computer 102 has the right to access the target computer 103a and 103b. If the authentication fails, the client computer 102 is denied access to the target computer 103a and 103b.

At step 203, if the authentication passes, the access request is processed to determine if the client computer 102 has the right to perform the intended task specified in the access request. For example, if the request is to execute a command on the target computer 103a and 103b, the third party authority 104 analyzes whether the client computer 102 is allowed to execute the intended command on the target computer 103a and 103b. The third party authority 104 may perform error checking on the access request. For example, the third party authority 104 may check the access request for syntactical validity. Further, the third party authority 104 may use details in the request, such as the client computer 102 name, the point of origination of the access request, and the target computer 103a and 103b to match rules in an access control list to determine whether to allow the client computer 102 to access the target computer 103a and 103b. The rules in the access control list may be applied in a specific order, such as device/target computer 103a and 103b specific rules, command specific rules, and client computer 102 specific rules.

If the checks of the access request fail, the client computer 102 is denied access to the target computer 103a and 103b. At step 204, if the checks of the access request pass, the third party authority 104 grants access by sending the client computer 102 an access token. The access token may be a time-decaying token (i.e., the validity of the token deteriorates over a set period of time). The access toke may allow the client computer 102 to access the target computer 103a and 103b to perform the task. The access token includes an access key including the task (e.g., command, instruction(s), program) to be executed on the target computer 103a and 103b.

When the client computer 102 receives the access token from the third party authority 104, the client computer 102 establishes a secure communication channel with the target computer 103a and 103b. The target computer 103a and 103b may include the access control module 105 when the communication channel is established. At step 205, the client computer 102 sends the access token to the target computer 103a and 103b.

In an exemplary embodiment, prior to the target computer 103a and 103b sending the access token to the third party authority 104, the target computer 103a and 103b may perform error checking on the request, for example, to determine if it is formatted correctly. This type of pre-processing may help reduce work load on the third party authority 104 by preventing the third party authority 104 from expending resources on improperly formatted access tokens or requests.

When the target computer 103a and 103b receives the access token, the target computer 103a and 103b establishes a secure communication channel with the third party authority 104. At step 206, when the communication channel is established, the target computer 103a and 103b sends the received access token to the third party authority 104 for validation. For example, the original IP address, access token, and command dialog or instructions to be executed on the target computer 103a and 103b may be sent to the third party authority 104.

The validation process performed by the third party authority 104 may include several steps. For example, the third party authority 104 may check that the access token and/or original request of the client computer 102 sent to the third party authority 104 includes authentication information before processing the access token or original request. The third party authority 104 may check the access token and/or original request for syntactical validity. The third party authority 104 may use the details of the original request from the client computer 102, the access token, the point of origination of the original request and/or access token, and the target computer 103a and 103b to determine if the original request should be allowed. Because an access token may be assigned to a target computer, a client computer, and includes commands or instructions to be executed, this information may be used in conjunction with the access token to validate the original request.

If the access token cannot be reconciled with the original request from the client computer 102, the third party authority 104 does not allow the target computer 103a and 103b to execute the requested task or instructions and commands included in the token. Therefore, the target computer 103a and 103b denies access and disconnects from client computer 102. For example, the IP address of the client computer 102 where the original request came from may be matched against a safe list, and if the client computer 102 is not in the list, the client computer 102 may be denied access. At step 207, if the token is validated, the third party authority 104 allows the target computer 103a and 103b to process the requested task.

At step 208, when the target computer 103a and 103b is authorized to execute the requested task by, for example, the third party authority 104, the target computer 103a and 103b processes the requested task to determine the lowest level of access needed to perform the requested task. For example, a requested command to be executed on the target computer 103a and 103b is checked against a table of commands to determine the lowest level of access needed to execute the requested command (e.g., administrative level, user level, guest level, etc.). The access levels may be defined as rules or as a look-up table and may be modified as needed. In an alternative embodiment, the third party authority 104 may determine the lowest level of access needed to execute the requested task and send the appropriate level of access to the target computer 103a and 103b to give the client computer 102 during the access token validation stage.

At steps 209 and 210, once the third party authority 104 grants permission to execute the requested task, the target computer 103a and 103b spawns a thread to perform the requested task and gives the client computer 102 access at the lowest level needed to perform the requested task. The commands executed on the target computer 103a and 103b may collect diagnostic information, correct an issue with the target computer 103a and 103b, or confirm an alarm's validity on the target computer 103a and 103b. For example, if an alarm states that the target computer 103a and 103b has had the event log service fail, then the access control module 105 or target computer 103a and 103b may securely run a restart service command on the target computer 103a and 103b.

At step 211, the client computer 102 monitors the target computer 103a and 103b during execution of the requested task to ensure no unexpected problems or issues are detected. For example, memory, concurrent connections, connection rates and/or processor utilization may be monitored on a graphical interface (e.g., time-chart) to determine if the execution of the requested task is causing unexpected or adverse effects on the target computer 103a and 103b. If a problem is detected (e.g., long period of processing, errors, unexpected peripheral activities, etc.), the client computer 102 can then have the opportunity to remediate the problem and/or abort the task to protect the target computer 103a and 103b. If the requested task is processor and/or memory intensive, the client computer 102 monitors the resource utilization of the target computer 103a and 103b and requests subsequent task requests, whether from the same client computer or different client computers, to be held in queue. The target computer 103a and 103b may truncate the request if a client computer's monitoring is using too many resources.

To ensure that the spawned thread does not cause the target computer 103a and 103b to “hang,” the client computer 102 monitors the data stream to mimic a “time out” feature. For example, the data stream from the target computer 103a and 103b is monitored to determine if the data stream contains signs that the requested task has begun. If no such data is detected over a set period of time, the requested task is aborted by, for example, the client computer 102 to prevent the target computer 103a and 103b from being occupied too long with a request that is not getting processed or to unnecessarily hold other client devices in queue.

At step 212, once the requested task has been processed, an acknowledgement is sent to the client computer 102 to indicate that the requested task has been completed and the communication between the client computer 102 and the target computer 103a and 103b is then closed.

In an exemplary embodiment, the methods and systems of the present invention are implemented using XML. Other programming languages may be used without departing from the scope of the invention. An XML request schema may be used to communicate between the client computer 102 and third party authority 104. A request type may be set to ‘issueToken’ so that the third party authority 104 knows what is being requested. The host name of the target computer 103a and 103b is also defined. The dialog (i.e., instruction(s), commands, programs) that will be executed on the target computer 103a and 103b is also provided.

<request type=“issueToken” target=“testHost”>
<dialog>
<interaction type=“constructor” command=“cmd.exe”
arguments=“” timeout=“10” failOnTimeout=“false” prompt=“>” />
<interaction type=“normal” command=“echo ” test Anthony“”
timeout=“10” failOnTimeout=“false” prompt=“>” />
<interaction type=“destructor” command=“exit”
timeout=“1” waitForExit=“5”
prompt=“READ_IT_ALL” />
</dialog>
</request>

An XML request schema may be used to communicate between the client computer 102 and the access control module 105 or the target computer 103a and 103b. The request may begin with the overall number of minutes it will require to run.

<request timeout=“5”>

A credential node may contain the access token. For example, four may tell the client computer 102 to request an access token from the third party authority 104.

<credential token=“****” />
<dialog>

An example of the dialog between the client computer 102 and the access control module 105 or the target computer 103a and 103b may be implemented using XML.

<interaction type=“constructor” command=“cmd.exe”
arguments=“” timeout=“10” failOnTimeout=“false” prompt=“ >” />

The type “constructor” refers to the nature of the command and may be the command that spawns a process that is called. The type may also be normal, observe or destructor. CMD.exe may be used to run other commands. Timeout refers to the number of seconds to look for output and to wait before running the next item. FailOnTimeout refers to whether the operation should continue if there is a time out, or if the process should be killed. Prompt refers to the termination string at the end of the output. This may be required to be at the end of the output.

The CMD.exe process may be used to run another command, such as the psinfo.exe.

<interaction type=“normal” command=“bin\psinfo.exe /accepteula”
timeout=“10” failOnTimeout=“false” prompt=“>” />

The client computer 102 may then disconnect from the target computer 103a and 103b. For example, “exit” may be sent to the Standard In of cmd.exe, and this will cause CMD to exit. In a second example, if a client computer 102 does not disconnect or if this command does not work, the process is killed when the end of the dialog is reached.

<interaction type=“destructor” command=“exit” timeout=“1”
waitForExit=“5” prompt=“READ_IT_ALL” />
</dialog>
</request>

In an exemplary embodiment, various XML requests may be issued by the target computer 103a and 103b or access control module 105 to log messages with the third party authority 104 or to validate a request that was made by a client computer 102. For example, the following request may be used to log a message with the third party authority 104:

<request type=“serverLog”>
<log host=“serverHostname” client=“client” type=“1” eventid=“1”>
<![CDATA[ Exception details here. ]]>
</log>
</request>

In another example, the following request may be used to validate a request with the third party authority 104:

<request type=“validation” target=“testHost” source=“10.123.2.3”
constructor=“cmd.exe” token=“34435475756fgvcnbjhgjd”>

The type may refer to the type of validation request. The target may refer to the hostname of the target computer 103a and 103b or the target computer 103a and 103b the access control module 105 is running on. Source may refer to the IP address the request came from. Constructor may refer to the command that is listed as the constructor in the dialog. Token may refer to the access token the client computer 102 is presenting for the request.

An example of the dialog or instructions that the access control module 105 or the target computer 103a and 103b may run based on a request is:

<dialog>
<interaction type=“constructor” command=“cmd.exe”
arguments=“” timeout=“10” failOnTimeout=“false” prompt=“>” />
<interaction type=“normal” command=“echo ”
test Anthony“” timeout=“10” failOnTimeout=“false” prompt=“>” />
<interaction type=“destructor” command=“exit”
timeout=“1” waitForExit=“5” prompt=“READ_IT_ALL” />
</dialog>
</request>

In an exemplary embodiment, the target computer 103a and 103b or access control module 105 may send results to the client computer 102. For example, the results XML, as shown below, may begin with information about the connection, such as the endpoints, security level, and authentication results.

```
<results generatedBy=“CFPIES1GPRT001”
requestedBy=“10.11.138.12:2115”
initiated=“3/9/2008 8:18:25 PM”>
<connection evaluatedBy=“CFPIES1GPRT001” protocol=“Ssl3”>
<cipher type=“Rc4” strength=“128” />
  <hash type=“Md5” strength=“128” />
  <keyExchange type=“RsaKeyX” strength=“1024” />
  <revocation isRevoked=“False” />
<certificate endPoint=“CFPIES1GPRT001” issuedTo=“CN=GateKeeper,
OU=TOC Strategic Services, O=COMPANY, L=New York,
S=New York, C=US” effectiveDate=“3/4/2008 1:03:36 AM”
expirationDate=“3/2/2017 1:03:36 AM” />
  <certificate endPoint=“10.11.138.12:2115” issuedTo=“NULL”
effectiveDate=“NULL” expirationDate=“NULL” />
<sslTunnel isAuthenticated=“True” isSigned=“True”
isEncrypted=“True” isServer=“True” />
<transport canRead=“True” canWrite=“True” canTimeout=“True” />
  </connection>
  <validationRequest status=“success” tokenId=“31703” />
```

Information on the results of the request may be provided by the target computer 103a and 103b or access control module 105, including metrics on resource utilization, to the client computer 102. Each step in the request may have a corresponding section in a sub-tree of the XML response as shown.

<dialogResults>
<metrics process=“cmd” peakMem=“1605632”
cpuTime=“00:00:00.0156250” runTime=“00:01:21.0645752”
readEfficacy=“1152” readMaxEfficacy=“3208”
readTotal=“89869” readAttempts=“78” />

The command and arguments may be restated to provide confirmation that the results are for the command the client computer 102 ran. DidTimeout may indicate if the client computer-specified “prompt” was reached before a timeout.

```
  <interactionResult id=“0” didTimeout=“True” type=“constructor”
  command=“cmd.exe”
  arguments=“” timeout=“10” failOnTimeout=“false”
  prompt=“C:\Patronus>”>
    <![CDATA[
    Microsoft Windows [Version 5.2.3790]
    (C) Copyright 1985-2003 Microsoft Corp.
    C:\WINDOWS\system32>
    ]]>
  </interactionResult>
  <interactionResult id=“1” didTimeout=“True” type=“normal”
  command=“C:\Patronus\bin\psloggedon.exe /accepteula”
  timeout=“15” failOnTimeout=“false”
  prompt=“C:\Patronus>”>
    <![CDATA[
    Users logged on locally:
      Error: could not retrieve logon time
    NT AUTHORITY\LOCAL SERVICE
      Error: could not retrieve logon time
    NT AUTHORITY\NETWORK SERVICE
      Error: could not retrieve logon time
    LEH\SVCSQLSRV
      3/9/2008 12:27:42 PM LEH\8anvirtu
      Error: could not retrieve logon time
    LEH\svcgprt
      Error: could not retrieve logon time
    LEH\svcv2ipr
      Error: could not retrieve logon time
    NT AUTHORITY\SYSTEM
    No one is logged on via resource shares.
    C:\WINDOWS\system32>
  ]]>
  </interactionResult>
<interactionResult id=“2” didTimeout=“True” type=“normal”
command=“dir c:\” timeout=“5” failOnTimeout=“false”
  prompt=“C:\Patronus>”>
    <![CDATA[
    Volume in drive C is Lehman-C
    Volume Serial Number is 64CC-E97A
    Directory of c:\
    07/12/2007 09:36 AM  0 AUTOEXEC.BAT
    07/12/2007 11:11 AM  <DIR>  Build
    10/05/2007 12:57 PM  <DIR>  calibration
    07/12/2007 09:50 AM  <DIR>  compaq
    07/12/2007 09:36 AM  0 CONFIG.SYS
    07/12/2007 09:51 AM  <DIR>  CPQSYSTEM
    07/12/2007 10:54 AM  <DIR>  DBMS
    03/01/2008 07:38 AM  <DIR>  DMLogs
    03/09/2008 12:27 PM  <DIR>  Documents and Settings
    07/12/2007 12:22 PM  <DIR>  drivers
    07/27/2007 09:27 AM  <DIR>  GPRT_MONITOR
    09/17/2007 11:40 PM  8,853 HD0000003458025.cer
    03/04/2008 02:09 AM  8,781 HD0000004149491.cer
    07/12/2007 09:53 AM  <DIR>  hp
    10/05/2007 04:31 PM  <DIR>  impostors
    01/07/2008 05:36 PM  <DIR>  Inetpub
    10/06/2007 10:47 PM  <DIR>  IPIVR_ROUTING
    03/09/2008 05:12 PM  <DIR>  Patronus
    07/18/2007 12:52 PM  <DIR>  Persay PDR
    07/18/2007 12:48 PM  <DIR>  PersayLogs
    02/09/2008 12:36 PM  <DIR>  Program Files
    08/14/2007 11:54 AM  <DIR>  Sentinel
    09/10/2007 05:24 PM  <DIR>  temp
    02/27/2008 10:14 AM  <DIR>  test
    08/01/2007 06:14 AM  <DIR>  usr
    07/12/2007 04:02 PM  <DIR>  utils.nt
    10/05/2007 01:24 PM  <DIR>  verify
    01/14/2008 04:39 PM  <DIR>  verizonEbonding
    02/14/2007 04:54 PM  24,576 VPCntx.dll
    03/09/2008 08:19 PM  <DIR>  WINDOWS
    07/12/2007 09:36 AM  <DIR>  wmpub
    07/18/2007 01:23 PM  <DIR>  wrk
          5 File(s)  42,210 bytes
          27 Dir(s) 19,148,582,912 bytes free
    C:\WINDOWS\system32>
  ]]>
  </interactionResult>
<interactionResult id=“6” didTimeout=“True” type=“destructor”
command=“exit” timeout=“1” waitForExit=“5”
  prompt=“READ_IT_ALL” foredExit=“False”>
<![CDATA[
  ]]>
  </interactionResult>
```

At the end of the interaction between the target computer 103a and 103b or access control module 105, the content of standard error may be retrieved as shown below.

```
<standardError>
      <![CDATA[
      ]]>
  </standardError>
  </dialogResults>
  </results>
```

It will be apparent to those skilled in the art that various modifications and variations can be made in the system and method for secure remote computer task automation of the present invention without departing form the spirit or scope of the invention. Thus, it is intended that the present invention cover the modifications and variations of this invention provided they come within the scope of the appended claims and their equivalents.

What is claimed is:

1. A method, comprising:
receiving at a third party authority a request from a client computer, the request including authentication information and an access request;
authenticating the client computer based on the authentication information;
processing the access request to grant the client computer access to a target computer to perform a task on the target computer, the access request including the task;
sending an access token to the client computer to access the target computer to perform the task;
receiving the access token from the target computer for validation; and
validating the received access token based on the request for the target computer to process the task.

2. The method of claim 1, wherein the access request contains an identity of the target computer and a command to be executed on the target computer to process the task.

3. The method of claim 1, wherein the request is sent over a secure communication channel.

4. The method of claim 1, wherein the access token is a time-decaying token.

5. The method of claim 1 further comprising the step of determining a lowest level of access for the client computer to access the target computer to perform the task.

6. A method, comprising:
sending a request including authentication information and an access request, from a client computer to a third party authority;
receiving an access token from the third party authority at the client computer;
sending the access token from the client computer to a target computer; and
accessing the target computer to perform a task on the target computer.

7. The method of claim 6, wherein the request is sent over a secure communication channel.

8. The method of claim 6, wherein the access request contains an identity of the target computer and a command to be executed on the target computer to process the task.

9. The method of claim 6 further comprising monitoring for an issue while performing the task.

10. The method of claim 6 further comprising monitoring to determine if a time out has occurred.

11. The method of claim 9 further comprising the step of remediating the issue.

12. The method of claim 9 further comprising the step of aborting the task if the issue is detected on the target computer.

13. The method of claim 6, wherein the step of accessing the target computer further comprises accessing the target computer at a determined lowest level of access to perform the task.

14. A method, comprising:
receiving an access token at a target computer;
sending the access token to a third party authority for validation;
receiving validation from the third party authority to process a task;
processing the task;
granting a client computer access to the target computer to perform the task;
spawning a thread to process the task on the target computer; and
sending to the client computer an acknowledgement indicating a status of the task.

15. The method of claim 14 further comprising the step of establishing a secure communication channel with the third party authority after receiving the access token.

16. The method of claim 14 further comprising the step of determining a lowest level of access needed to perform the task.

17. The method of claim 16 further comprising the step of comparing the task to a table of tasks to determine the lowest level of access needed to perform the task.

18. The method of claim 16, wherein the step of granting the client computer access comprises granting the client computer access at the determined lowest level of access.

19. A computer program product including a computer readable medium having stored thereon computer executable instructions that, when executed by a computer, direct the computer to perform a method comprising the steps of:
receiving a request from a client computer, the request including authentication information and an access request;
authenticating the client computer based on the authentication information;
processing the access request to grant the client computer access to a target computer to perform a task on the target computer, the access request including the task;
sending an access token to the client computer to access the target computer to perform the task;
receiving the access token from the target computer for validation; and
validating the received access token based on the request for the target computer to process the task.

20. The computer program product of claim 19, wherein the access request contains an identity of the target computer and a command to be executed on the target computer to process the task.

21. The computer program product of claim 19, wherein the request is sent over a secure communication channel.

22. The computer program product of claim 19, wherein the access token is a time-decaying token.

23. The computer program product of claim 19 further including computer executable instructions that, when executed by the computer, configure the computer to perform the step of determining a lowest level of access for the client computer to access the target computer to perform the task.

24. A computer program product including a computer readable medium having stored thereon computer executable instructions that, when executed by a computer, direct the computer to perform a method comprising the steps of:
sending a request including authentication information and an access request to a third party authority;
receiving an access token from the third party authority;
sending the access token to a target computer; and
accessing the target computer to perform a task on the target computer.

25. The computer program product of claim 24, wherein the request is sent over a secure communication channel.

26. The computer program product of claim 24, wherein the access request contains an identity of the target computer and a command to be executed on the target computer to process the task.

27. The computer program product of claim 24 further including computer executable instructions that, when executed by the computer, configure the computer to perform the step of monitoring for an issue while performing the task.

28. The computer program product of claim 24 further including computer executable instructions that, when executed by the computer, configure the computer to perform the step of monitoring to determine if a time out has occurred.

29. The computer program product of claim 27 further including computer executable instructions that, when executed by the computer, configure the computer to perform the step of remediating the issue.

30. The computer program product of claim 27 further including computer executable instructions that, when executed by the computer, configure the computer to perform the step of aborting the task if the issue is detected on the target computer.

31. The computer program product of claim 24 further including computer executable instructions that, when executed by the computer, configure the computer to perform the step of accessing the target computer at a determined lowest level of access to perform the task.

32. A computer program product including a computer readable medium having stored thereon computer executable instructions that, when executed by a computer, direct the computer to perform a method comprising the steps of:
receiving an access token
sending the access token to a third party authority for validation;
receiving validation from the third party authority to process a task;
processing the task;
granting a client computer access to the computer to perform the task;
spawning a thread to process the task on the computer; and
sending to the client computer an acknowledgement indicating a status of the task.

33. The computer program product of claim 32 further including computer executable instructions that, when executed by the computer, configure the computer to perform the step of establishing a secure communication channel with the third party authority after receiving the access token.

34. The computer program product of claim 32 further including computer executable instructions that, when executed by the computer, configure the computer to perform the step of determining a lowest level of access needed to perform the task.

35. The computer program product of claim 34 further including computer executable instructions that, when executed by the computer, configure the computer to perform the step of comparing the task to a table of tasks to determine the lowest level of access needed to perform the task.

36. The computer program product of claim 34, wherein granting the client computer access comprises granting the client computer access at the determined lowest level of access.

37. A system, comprising:
a third party authority in communication with a client computer and a target computer;
the third party authority configured to:
receive a request from the client computer, the request including authentication information and an access request,
authenticate the client computer based on the authentication information,
process the access request to grant the client computer access to the target computer to perform a task on the target computer, the access request including the task,
send an access token to the client computer to access the target computer to perform the task,
receive the access token from the target computer for validation, and
validate the received access token based on the request for the target computer to process the task.

38. The system of claim 37, wherein the access request contains an identity of the target computer and a command to be executed on the target computer to process the task.

39. The system of claim 37, wherein the access token is a time-decaying token.

40. The system of claim 37, wherein the target computer is further configured to determine a lowest level of access for the client computer to access the target computer to perform the task.

41. A system, comprising:
a client computer in communication with a third party authority and a target computer;
the client computer configured to:
send a request including authentication information and an access request to the third party authority,
receive an access token from the third party authority,
send the access token to the target computer, and
access the target computer to perform a task on the target computer.

42. The system of claim 41, wherein the access request contains an identity of the target computer and a command to be executed on the target computer to process the task.

43. The system of claim 41, wherein the client computer is further configured to monitor for an issue while performing the task.

44. The system of claim 41, wherein the client computer is further configured to monitor to determine if a time out has occurred.

45. The system of claim 43, wherein the client computer is further configured to remediate the issue.

46. The system of claim 43, wherein the client computer is further configured to abort the task if the issue is detected on the target computer.

47. The system of claim 41, wherein the client computer is further configured to access the target computer at a determined lowest level of access to perform the task.

48. The system, comprising:
a target computer in communication with a third party authority and a client computer;
the target computer configured to:
receive an access token,
send the access token to a third party authority for validation,
receive validation from the third party authority to process a task,
process the task,
grant the client computer access to perform the task,
spawn a thread to process the task, and
send to the client computer an acknowledgement indicating a status of the task.

49. The system of claim 48, wherein the target computer is further configured to determine a lowest level of access needed to perform the task.

50. The system of claim 49, wherein the target computer is further configured to compare the task to a table of tasks to determine the lowest level of access needed to perform the task.

51. The system of claim 49, wherein the target computer is further configured to grant the client computer access at the determined lowest level of access.
